(19) United States
(12) Patent Application Publication
(10) Pub. No.: US 2008/0083154 A1
(43) Pub. Date: Apr. 10, 2008

(54) BAIT RETENTION FISH HOOK

(76) Inventor: Timothy M Gregory, Alpharetta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/867,797

(22) Filed: Oct. 5, 2007

Related U.S. Application Data
(60) Provisional application No. 60/849,545, filed on Oct. 5, 2006.

(51) Int. Cl. A01K 83/06; A01K 83/00

(52) U.S. Cl. 43/44.8; 43/43.16

(57) ABSTRACT

A fishing hook with bends or kinks that assist in maintaining bait on the hook is presented. The hook can be used alone or in conjunction with multiple other hooks. A double hook assembly with and S-bend is suitable for use with artificial bait such as frogs and worms. The double hook assembly may include an eye that is connected to a first hook and a second hook that also includes an s-bend that includes a first turn that is about a one eighth turn inward to the hook and that connects to or otherwise leads into a second turn outward that is about a quarter turn and that connects to or otherwise leads to a third turn inward that is about a quarter turn that connects to or otherwise leads to a fourth turn outward that is about a one eighth turn that connects to or otherwise leads to the eye.

### CROSS-REFERENCE TO RELATED APPLICATIONS

This application is a non-provisional application filed under 35 USC xxx and claiming the priority to the filing date of United States Provisional application for patent filed on Oct. 5, 2006 under the title of FISH HOOK and assigned Ser. No. 60/849,545.

### BACKGROUND OF THE INVENTION

The present invention relates to fish hooks and fishing lures.

Anyone that dives into the world of fishing soon finds that there is much to learn. Are you fishing in fresh water or salt water? Are you using real bate, live bait or artificial bait? What type of fish do you want to catch? Do you want high activity fishing or low activity fishing (i.e., cast and reel constantly or cast and sit and watch)? If you use live bate, what type of bait—crickets, worms, grubs, minnows (and what type of minnow). It does not take long to realize that entering into this world can be daunting. A quick trip to the local fishing tackle store can easily confirm this as you wander down isle after isle of artificial lures, hooks, jigs, weights, etc.

Anglers come in all shapes and sizes, from all sorts of backgrounds, and may all have a different reason or world to escape from but, the most common thing about the variety of anglers, whether seated on an overstuffed swivel chair poised on the deck of a $50,000 Ranger Z21, sitting in a lawn chair on a dock, or hanging over the side of a bridge, is that they are there to catch fish.

Anglers and fisherman are always looking for better ways to catch fish—anything that will give man an edge over “the one that got away” is coveted. Over the years, many items have been developed to help improve the sport in many ways. Examples of some devices that have been developed to improve the fishing experience include: a spinner bait that incorporates an articulating connector as described in U.S. Pat. No. 6,082,039 to McGuinness; a lighted fishing lure as described in U.S. Patent Application no. 2006/0096152 to Pelegrin; and a weighted shank fish hook described in U.S. Patent Application no. 2006/0191187 to Falcon.

U.S. Pat. No. 6,634,135 to Rydell describes a double hook lure that is intended to reduce the tendency of artificial bait to slide down the shank of a hook by placing two soft bodied plastic baits, i.e. worms, each one onto a shaft of a double hook that is formed from a single length of wire.

Other than wanting to catch fish, another desire shared by most sane fishermen is that of not wanting to lose their bait—regardless of whether it is real, live and especially the expensive artificial bait. Delving into the world or artificial lures, and more specifically, hook-mounted artificial lures, there is a need in the art for an improved technique to encourage bait to remain on the hook. Several techniques have been introduced to address this issue; however, there is still a need in the art for a hook that can be used as a single hook, or in a multi-hook configuration, that improves the ability for holding artificial bait.

### BRIEF SUMMARY OF THE INVENTION

In general, the various embodiments, aspects and features of the present invention are directed towards the above-described needs in the art, as well as other needs, by providing a hook with kinks or bends and that is operative to hold any type of bait in position. One embodiment of the present invention includes a double hook assembly including at least one kink. In one group of embodiments, the double hook assembly includes a double kink. For example, the hook assembly may include an eye that is connected to a first hook and a second hook that also includes a double kink that includes a first inward turn that is about a one eighth turn that connects to or otherwise leads into a first outward turn that is about a quarter turn that connects to or otherwise leads to a second inward turn that is about a quarter turn that connects to or otherwise leads to a second outward turn that is about a one eighth turn that connects to or otherwise leads to the eye.

In another example, the double kink includes a first inward turn a turn of about 45o or greater that connects to or otherwise leads into a first outward turn of about 90o or greater that connects to or otherwise leads to a second inward turn a turn of about 90o or greater that connects to or otherwise leads to a second outward turn that is a turn of about 45o or greater that connects to or otherwise leads to the eye. In certain desirable embodiments, the double hook assembly is formed from a shape memory alloy or a superelastic alloy. For example, the alloy may be titanium or an alloy of titanium, predominantly nickel or an alloy of nickel. Suggested alloys are alloys that include from about 40 to about 50 weight percent of titanium, from about 50 to about 60 weight percent of nickel and from about 0 to about 10 weight percent of other elements. In certain embodiments, the shank of the first hook and the shank of the second hook diverge from a point and form an angle “θ” between the shanks and the angle “θ” is between about 5 o and about 50o. In other embodiments, the shank of the first hook and the shank of the second hook diverge from a point and form an angle “θ” between the shanks and the angle “θ” is between about 5o and about 40o, between about 5o and about 30o, between about 10o and about 30o, between about 15o and about 30o, and between about 15o and about 25o.

### BRIEF DESCRIPTION OF THE SEVERAL VIEWS OF THE DRAWING

A full and enabling disclosure of the present invention, including the best mode thereof is set forth in the detailed description which makes reference to the appended figures in which:

FIG. 1 illustrates a single-hook embodiment of the present invention.

FIG. 2 is a perspective diagram of a two-hook assembly but can also be referred to as a double hook or a double hook assembly.

FIG. 3 is an end-side view of the two-hook assembly shown in FIG. 2.

FIG. 4 is a conceptual diagram of the double hook embodiment of the invention inserted within a soft lure structure.

FIG. 5 is a side view of an alternate embodiment of the present invention.

FIG. 6 is yet another alternate embodiment of the present invention which includes a separate bait retention structures for two adjoined hooks in a hook assembly.

### DETAILED DESCRIPTION OF THE INVENTION

The various embodiments, features and aspects of the present invention are directed towards providing an improved fishing hook apparatus and/or assembly that advantageously operates to hold bait in position on the hook. In one embodiment of the invention, a hook is provided with an s-bend or double-kink near the eyelet. Advantageously, bait that has been placed on the hook and manipulated through the s-bend will be supported to stay in position by the s-bend. In another embodiment, two hooks are joined together along the shaft extending from the eyelet and jointly provide an s-bend of double-kink near the eyelet. In other embodiments, a single kink or multiple additional kinks can be included in the hook assembly.

Turning now to the drawings in which like labels represent like elements throughout the drawings, various aspects, features and embodiments of the present invention will be presented in more detail. The examples set forth in the drawings and the detailed description are provided by way of explanation of the invention and are not meant as limitations of the invention. The present invention thus includes any modifications and variations of the following examples as come within the scope of the appended claims and their equivalents.

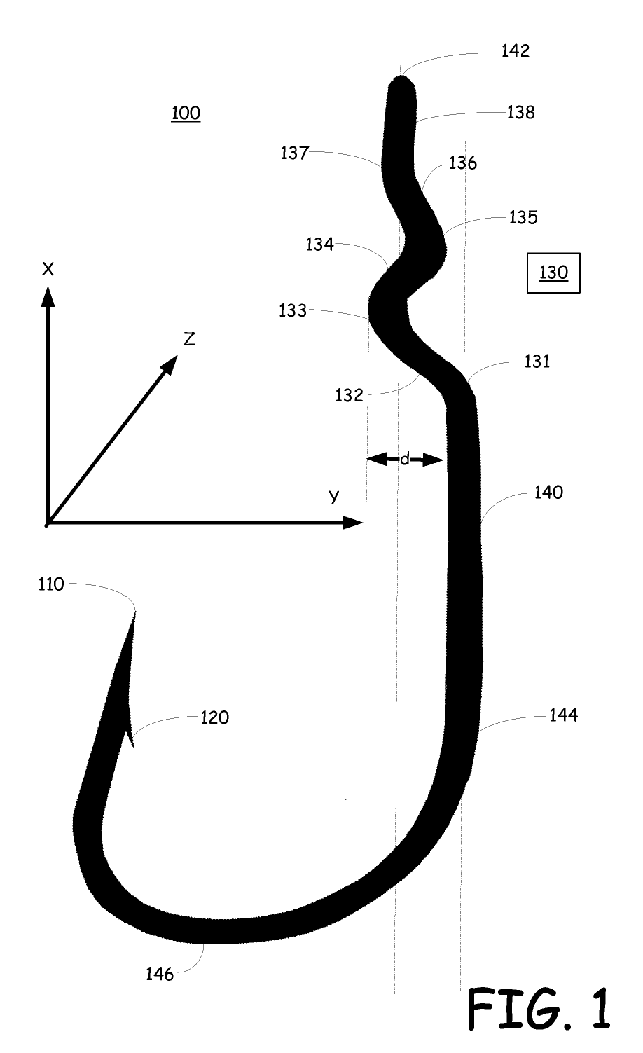

FIG. 1 illustrates a single-hook embodiment of the present invention. The hook 100 includes an optional barb 120. It should be noted that although barbs may be preferred in many instances and may in and of themselves be considered as aspects of the novelty of one or more embodiments of the present invention, the barbs are optional and need not be included in the hook assemblies of all embodiments of the present invention. In addition, the hook may include multiple barbs, either placed in tandem on the same side of the hook, opposing sides or in any orientation to each other.

The hook 100 includes a first point 110, a hook-bend 146 and a shank 140 that all exist in a single plane (the X-Y plane) and define the main shape of the hook 100. The illustrated hook 100 includes a bait retention structure 130 that includes a series of bends in the shank 140. In the various embodiments, the bait retention structure 130 may include differing numbers of bends and although the illustrated embodiment may be considered novel, the present invention is not limited to any particular number of bends in the bait retention structure 130. The shape of the bait retention structure 130 can vary from embodiment to embodiment and although the present invention is not limited to one particular structure, the specifically detailed structure may be considered novel. In the illustrated embodiment, the bends exist in the same plane as the hook (the X-Y plane) and form an S-bend or sinusoidal shape. In FIG. 1, the bait retention structure 130 is shown as existing on the shaft 140 between eyelet 142 and the beginning of the hook bend 144.

As previously stated, several bends can be provided in the shank 140 to form the bait retention structure 130. Each bend can vary in the angle and direction, and in some embodiments, may even break plane with the hook (i.e., move in the Z direction). In the embodiment illustrated in FIG. 1, the bait retention structure 130 is a double kink where a kink is defined as a bend at one angle from the shank 140 and then another bend at another angle back in the direction of and extending to the original Y axis of the shank 140.

In other embodiments, the bait retention structure 130 may form an N-shaped by having two kinks of at least about a quarter turn or at least about 90° in close proximity to each other and making sharp turns rather than rounded or gradual turns. The kinks may also be in other shapes including square bends, rounded bends, sharp pointed bends, twisted bends, etc. Although the kink shapes appearing in the illustrated embodiments may be considered novel, the present invention is not necessarily limited to any particular kink shape.

More specifically, in the embodiment illustrated in FIG. 1, the bait retention structure 130 includes a first turn 131 of the shank 140 in a first X-Y direction having a sloop of m1. A first portion 132 of the shank 140 then continues in this direction to a second turn 133. The second turn results in a second portion 134 of the shank 140 extending in a second X-Y direction at a slope of m2. The second portion 134 continues in this direction to a third turn 135. The third turn results in a third portion 136 of the shank 140 extending in a third X-Y direction at a slope of m3. The third portion 136 continues in this direction to a fourth turn 137. The fourth turn 137 results in a fourth portion 138 extending in a fourth X-Y direction at a slope of M4. The fourth portion 138 continues to the eyelet 142.

In the illustrated embodiment, the first turn 131 is approximately ⅛^{th} of a full circle turn and the second turn 133 is approximately ¼^{th} of a full circle turn. Similarly, the third turn is approximately ¼^{th} of a full circle turn and the fourth turn is approximately ⅛^{th} of a full circle turn. It will be appreciated that the portion 138 is shown as being substantially parallel to the shank 140 but not in alignment along the X-axis.

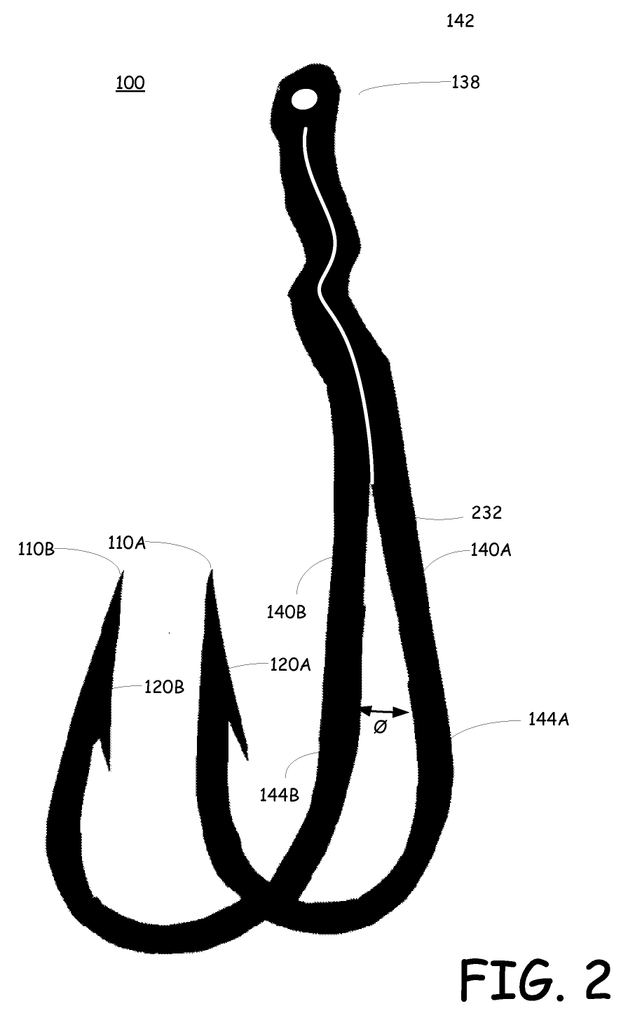

FIG. 2 is a perspective diagram of a two-hook assembly 200 but can also be referred to as a double hook or a double hook assembly. In the illustrated embodiment, the hook assembly 200 is formed from a first hook 100A and a second hook 100B, each having a corresponding bait retention structure 130. The two hooks are permanently attached together, for example by brazing, to form a single, integrated double hook assembly having one eye 242. The two hooks, first hook 100A and second hook 100B, of hook assembly 200 can be formed from one wire as is know in the art or the hook assembly 200 can be formed from two individual hooks 100A and 100B that are brazed, welded or otherwise joined together to form an integral one-piece assembly from two individual parts. If two hooks are welded or otherwise joined together it is suggested that only one of the hooks include an eye. A double hook assembly formed from one piece, that is a single length of wire, will have an eye formed in the middle of the length of wire and two parallel shanks extending from the eye that each terminate after a semicircular bend at a hook point formed at each end of the wire after the bend. The first hook 100A and second hook 100B of the illustrated embodiments include optional barbs 120A and 120B, respectively. It should be noted that although barbs may be preferred in many instances, barbs are optional and need not be included in the hook assemblies of the present invention. The shanks may be permanently bent apart, for example mechanically deformed during manufacturing, at angle from each at a point 232 to form an angle “θ” between the lower parts of the shanks 140A and 140B that lead to points 110A and 110B, respectively.

Each of the hooks 100A and 100B of the illustrated hook assembly 200 may conform to the description as provided in connection with the hook 100 illustrated in FIG. 1.

In certain embodiments, the distance “d” between the outside of shank 140 and the peak of the turn 133 is at least two times the diameter of shank 140 as illustrated in FIG. 1 that shows the side view of the hook 100 that could be included in the double hook assembly 200 of FIG. 2. In some embodiments, at least one of the kinks or all of the kinks has a large amplitude. In certain embodiments, the distance “d” between the outside of shank 140 and the outside edge of the peak of turn 133 is at least three times the diameter of shank 140. And in certain embodiments, the distance “d” between the outside of shank 140 and peak of turn 133 is at least four times or greater the diameter of shank 140. The eyelet 142 may lie on the same line as the line of the shank 140 or may lie within the line of the shank 140 as illustrated in FIG. 1. Thus, in certain embodiments, the eye 40 is shifted from the X axis of the shank 140 and may be in the direction of the gape or interior of the hook or the opposite direction.

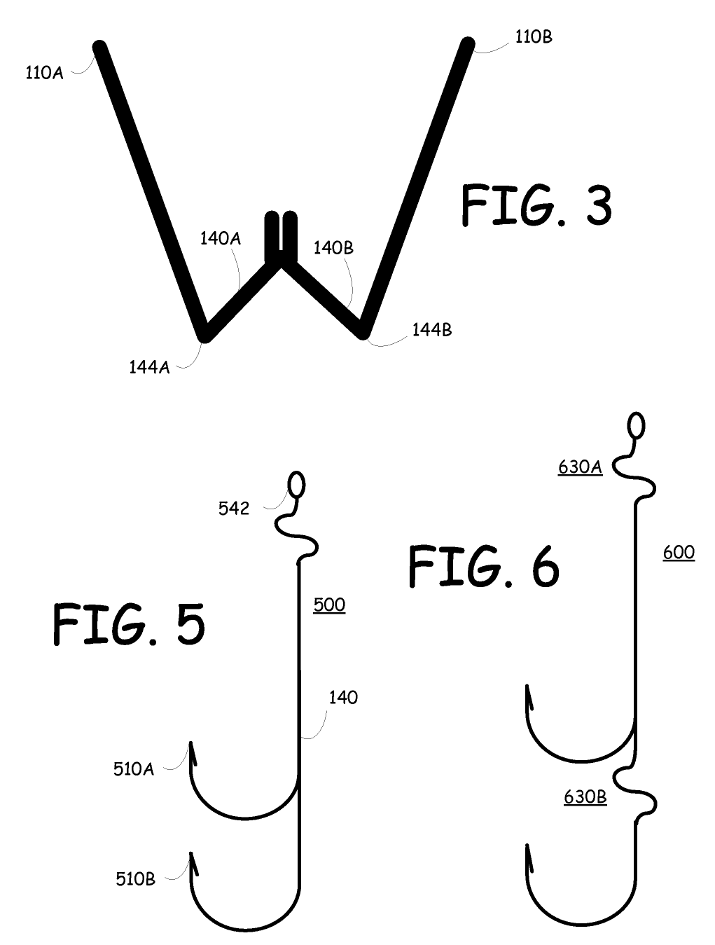

In certain desirable embodiments, the angle θ between the first plane of the first hook 100A and the second plane of the second hook 100B is between about 5° and about 50°, more desirably the angle θ between the first plane and the second plane is between about 5° and about 40°, still more desirably between about 5° and about 30°, still more desirably between about 10o and about 30°, still more desirably between about 15° and about 30°, and still more desirably between about 15° and about 25°. In addition, the points 110A and 110B of hooks 100A and 100B may toe or flare out, as shown in an exaggerated end-side view of FIG. 3, so that the distance between points 110A and 110B is greater than the distance between the corresponding points on the shanks 144A and 144B.

In certain embodiments, the hook assembly 200 is formed from or out of a shape memory alloy. Advantageously, shape memory alloys have the ability to be deformed, and in most cases seriously deformed, and then returned to their original shape. Double hook assemblies formed from shape memory alloys thus may be deformed so that the hook points can be inserted into soft, artificial bait.

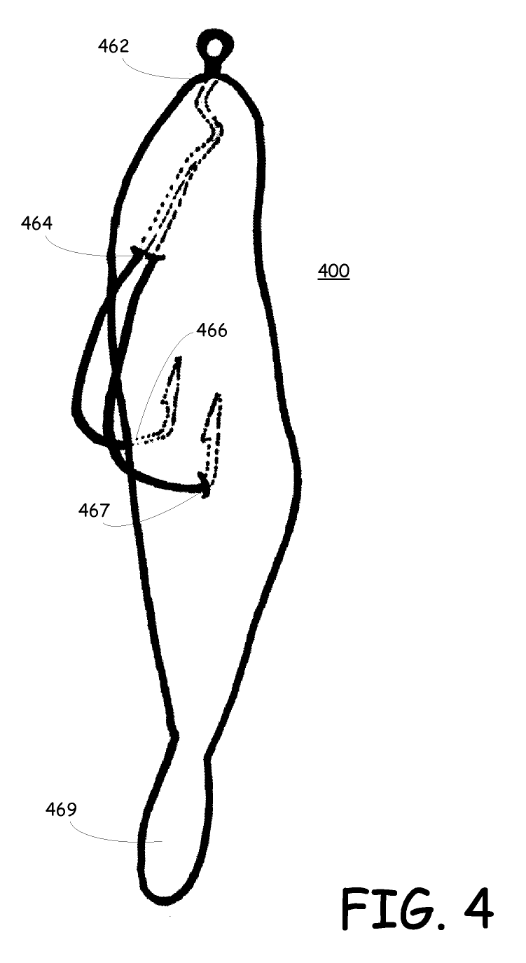

FIG. 4 is a conceptual diagram of the double hook embodiment of the invention inserted within a soft lure structure. The two points 110A and 110B of the hook assembly 200 can be pressed together by hand or finger pressure applied by an average individual so that the two points 110A and 110B can be inserted into a body 400 of a soft artificial lure through what is one hole 462, extended out of the body, at essentially one hole or two closely proximate holes 464, and then spring back to their original positions so that the two points 110A and 110B can be inserted further down the body of the soft artificial lure 400 at points 466 and 467 to provide a finished rig as illustrated in FIG. 4. The tail or the legs of the artificial lure 400 are generally designated at 469. Although hook assemblies of the present invention have been illustrated and described with respect to soft, plastic frog-like artificial bait, hook assemblies of the present invention can be used with various other types of baits, including both artificial and natural baits. For example, hook assemblies of the present invention can be used in conjunction with other soft artificial baits, including, but not limited to, worms, grubs, lizards, jerk baits, minnows, crawfish, chicken livers, tubes, trailers and other artificial baits made from a soft plastic or rubber material, all provided as non-limiting examples.

Shape memory alloys suitable for various embodiments of the present invention include, but are not limited to, alloys of titanium, nickel, alloys of nickel or alloys of nickel and titanium that may include other alloying elements. Examples of other alloying elements that may be included in the nickel and/or titanium alloys include, but are not limited to, copper, iron, chromium, vanadium, hafnium and palladium. In one group of embodiments, the hook assembly is formed from an alloy that comprises at least about 40 weight percent of titanium. In other embodiments, the hook assembly is formed from an alloy that comprises at least about 40 weight percent of titanium and at least about 50 weight percent of nickel. In still other embodiments, the hook assembly is formed from an alloy that comprises from about 50 to about 60 weight percent of nickel, more particularly from about 53 to about 58 weight percent of nickel and still more particularly from about 55 to about 56 weight percent of nickel with the majority of the remaining weight of the alloy being titanium. Desirably, such alloys are superelastic and maintain their superelastic properties within the temperature range of from about 30° F. to about 130° F.

One commercially available version of such a superelastic alloy is NiTinol shape memory alloy. NiTinol alloy is considered particularly advantageous because of its superior properties, such as, shape memory, corrosion resistance, resistance to cyclical fatigue, and flexibility compared to stainless steel and most other metals that are typically used for springs and other fishing lure components. Advantageously, NiTinol and other superelastic alloys possess superelastic properties that allow the alloy to return to its original shape after being deformed substantially. This property has made the NiTinol alloy popular for use in orthodontics, stents and other medical devices. Another example of an alloy of titanium is “beta” titanium which is an alloy of at least 40 weight percent of titanium and other metals that may include, but are not limited to, manganese, iron, chromium, cobalt, nickel, copper, tin and zirconium. Importantly, it is believed by the inventors that superelastic alloy springs and coils, and in particular, nickel/titanium alloy springs and coils, reduce and may even eliminate fraying of a fishing line. Other superelastic alloys may be used to form the hook assembly and may include alloys, but are not limited to, alloys of titanium and copper, chromium, and/or iron. Such alloys are also referred to as smart materials.

Advantageously, hook assemblies of the present invention can keep frogs and other soft artificial baits in place better and longer and can help prolong the useful life of the soft artificial bait. It is believed that the hook assemblies of the present invention that include a kink, a double kink, or more, keep the artificial bait in place better and longer and prevent the soft plastic areas around the hook from being further torn up and worn out, “hook tired”, as prior art double hooks. Another potential advantage of the hook assemblies of the present invention is that rigs, for example rig 400, using the hook assembly, tend to land in a right-side-up configuration or will right themselves in a matter of seconds. The rigs tend to right themselves and tend not to roll over on either side. The hook assembly advantageously helps to stabilize the rig in a manner similar to a keel on a boat.

FIG. 5 is a side view of an alternate embodiment of the present invention. In this embodiment, the hook assembly 500 includes two hooks, joined together similar to as described in other embodiments. In this embodiment however, the shank 140 of one hook is longer than shank of another hook, or the hooks are staggered in such a way that one barb 510A is closer to the eye 542 than the other barb 510B.

It will also be appreciated that although the invention has been described as including one or two hooks, than any number of hooks may be utilized in various embodiments of the present invention.

FIG. 6 is yet another alternate embodiment of the present invention which includes a separate bait retention structures 630A and 630B for two adjoined hooks in a hook assembly 600.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims. In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A hook assembly, the assembly comprising the components of:
a first hook having a shank and a curved portion;
a second hook having a shank and a curved portion;
a section of the shank of the first hook that is distal to the curved portion of the first hook being adjoined to a section of the shank of the second hook that is distal to the curved portion of the second hook; and
a bait retention structure corresponding to the adjoined portions of the shanks of the first hook and second hook.

2. The hook assembly of claim 1, wherein the bait retention structure further comprises at least one kink.

3. The hook assembly of claim 1, wherein the bait retention structure further comprises an s-bend.

4. The hook assembly of claim 3, wherein the hook assembly is constructed out of a single piece of wire.

5. The hook assembly of claim 3, wherein the hook assembly is constructed out of two pieces of wire.

6. A hook assembly comprising:
an eyelet connected to
a first hook and
a second hook and further comprising
a double kink that includes a first turn of about a one eighth turn in a first direction that is connects to or otherwise leads into a second turn that is about a quarter turn in a second direction that connects to or otherwise leads to a third turn that is about a quarter turn in a third direction that connects to or otherwise leads to a fourth turn that is about a one eighth turn in a fourth direction that connects to or otherwise leads to the eye.

7. The hook assembly of claim 6, wherein the first turn is a turn of about 45 degrees or greater, the second turn is a turn of about 90 degrees or greater, the third turn is a turn of about 90 degrees or greater and the fourth turn is a turn of about 45 degrees or greater.

8. The hook assembly of claim 6, wherein the hook assembly is formed from a shape memory alloy

9. The hook assembly of claim 6, wherein the hook assembly is formed from a superelastic alloy.

10. The hook assembly of claim 6, wherein the hook assembly is formed from titanium or an alloy of titanium.

11. The hook assembly of claim 6, wherein the hook assembly is formed from nickel or an alloy of nickel.

12. The hook assembly of claim 6, wherein the hook assembly comprises from about 40 to about 50 weight percent of titanium, from about 50 to about 60 weight percent of nickel and from about 0 to about 10 weight percent of other elements.

13. The hook assembly of claim 6, wherein the shank of the first hook and the shank of the second hook diverge from a point and form an angle “θ” between the shanks and the angle “θ” is between about 5 degrees and about 50 degrees.

14. The hook assembly of claim 6, wherein the shank of the first hook and the shank of the second hook diverge from a point and form an angle “θ” between the shanks and the angle “θ” is between about 5 degrees and about 40 degrees.

15. The hook assembly of claim 6, wherein the shank of the first hook and the shank of the second hook diverge from a point and form an angle “θ” between the shanks and the angle “θ” is between about 5 degrees and about 30 degrees.

16. The hook assembly of claim 6, wherein the shank of the first hook and the shank of the second hook diverge from a point and form an angle “θ” between the shanks and the angle “θ” is between about 10 degrees and about 30 degrees.

17. The hook assembly of claim 6, wherein the hook assembly is formed from a single wire.

18. The hook assembly of claim 6, wherein the hook assembly is formed of two wires that are connected together.

19. The hook assembly of claim 6, wherein the first hook is in a first plane and the second hook is in a second plane and the first and second planes intersect at the point at which the hooks diverge, and the first plane and the second plane diverge at an angle between 5 degrees and 45 degrees.

20. A hook assembly comprising:
an eyelet;
a first hook including a shank that extends from the eyelet to the hook bend;
a second hook including a shank that extend from the eyelet to the hook bend;
the first hook and second hook being connected at a second of the shank of the first hook and the shank of the second hook that is proximate to the eyelet; and
an s-bend positioned in the shank of the first and second hook.
